(19) United States
(12) Patent Application Publication
(10) Pub. No.: US 2008/0221933 A1
(43) Pub. Date: Sep. 11, 2008

(54) LIFE INSURANCE SYSTEM AND METHOD

(75) Inventor: William Gray, Minneapolis, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: THE TAX TRACK COMPANIES SYSTEM, Minneapolis, MN (US)

(21) Appl. No.: 11/936,034

(22) Filed: Nov. 6, 2007

Related U.S. Application Data
(60) Provisional application No. 60/864,462, filed on Nov. 6, 2006.

(51) Int. Cl. G06Q 40/00

(52) U.S. Cl. 705/4

(57) ABSTRACT

A system for providing life insurance with no out-of-pocket cost including a cost component, an increasing death benefit having a fixed portion and a rider portion, the rider portion being at least equal to a cumulative loan balance, and an investment vehicle configured to provide a rate of return on the cash component based on one or more financial market indices.

### CROSS-REFERENCE TO RELATED APPLICATIONS

The subject matter of this application is related to the subject matter of U.S. Provisional Patent Application No. 60/864,462, filed on Nov. 6, 2006, priority to which is claimed under 35 U.S.C. § 119(e) and which is incorporated herein by reference.

### BACKGROUND

Where a high net worth individual has the liquidity need to fund legacies for heirs or to avoid the perils of untimely liquidation of an Estate at death, life insurance is often the preferred vehicle. Life insurance generally renders the most convenient and tax-advantaged result for liquidity purposes due its essential properties of at least providing: (1) an immediate tax-free death benefit in excess of premiums paid; (2) non-taxed compounding of cash values; and (3) tax-free accessibility of cash values.

Life insurance is typically purchased with after-tax funds. However, for high net-worth individuals who obtain life insurance on a personal level for a trust, with annual premiums being gifted to the trust, purchasing conventionally with after-tax funds is generally a losing investment. In such a scenario, the funds to cover annual premiums are taxed twice, first via the individual's income tax (e.g. 35%) and then via the gift tax (i.e. 40%). Taking into account an “opportunity cost” associated with foregoing investment of the pre-tax value of the funds (e.g. 7.5%), the “actual” or “true” cost of the life insurance policy to the individual invariably exceeds the death benefit of the policy, often before the individual reaches his/her predicted life expectancy. This often holds true even when the gift tax is removed from the equation.

For these and other reasons, there is a need for embodiments described herein.

### SUMMARY

One embodiment describes a system for providing life insurance with no out-of-pocket cost including a cost component, an increasing death benefit having a fixed portion and a rider portion, the rider portion being at least equal to a cumulative loan balance, and an investment vehicle configured to provide a rate of return on the cash component based on one or more financial market indices.

### BRIEF DESCRIPTION OF THE DRAWINGS

FIG. 1 is a block diagram illustrating one embodiment of a system for providing life insurance.

FIG. 2 is a table illustrating an example embodiment of the system of FIG. 1.

FIG. 3 is a graph illustrating the average returns of the S&P Index.

FIG. 4 is a table illustrating the annual rate of return of the S&P Index.

FIG. 5 is a table illustrating an example embodiment of the system of FIG. 1.

FIG. 6 is a table illustrating an example embodiment of the system of FIG. 1.

FIG. 7 is a table illustrating the performance of selected global financial indices and an account investment vehicle according to one embodiment.

FIG. 8 is a graph illustrating the performance of an account investment vehicle according to one embodiment.

FIG. 9 is a graph illustrating the performance of an account investment vehicle according to one embodiment.

FIG. 10 is a table illustrating collateral requirements of the example embodiment of FIG. 2.

### DETAILED DESCRIPTION

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

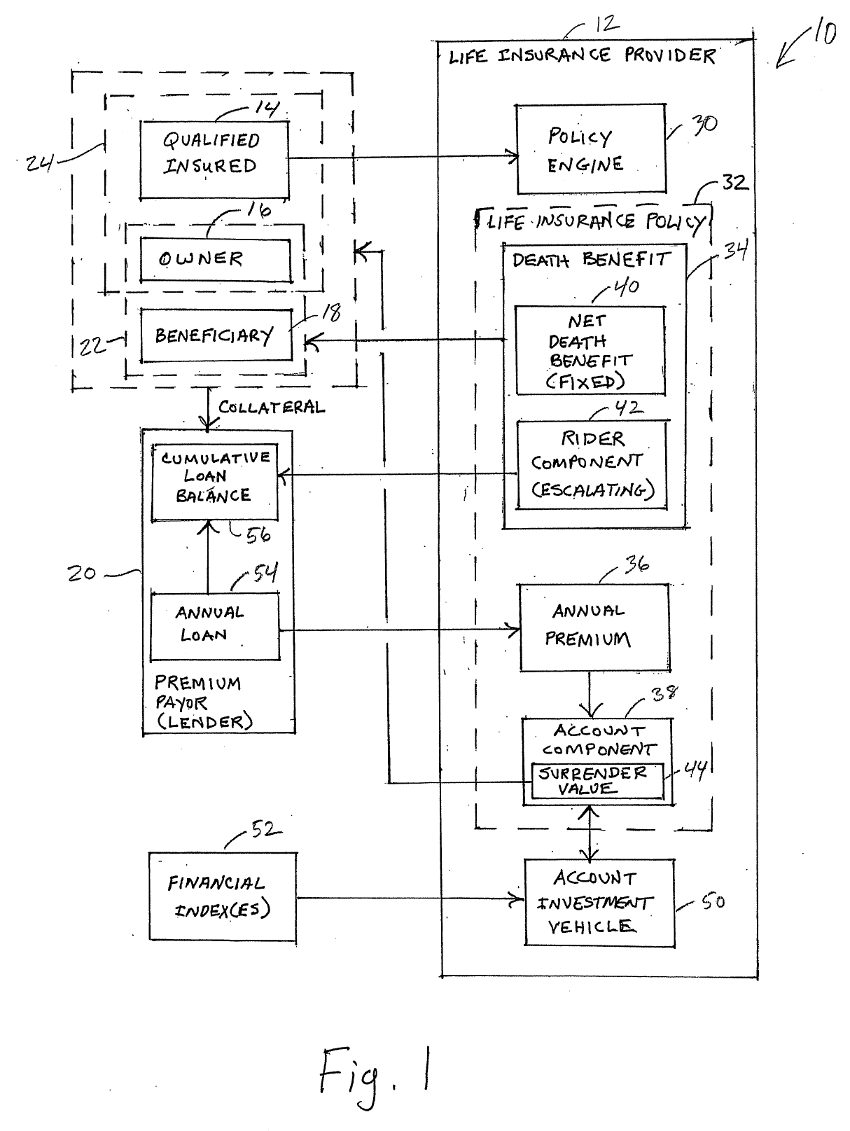

FIG. 1 is a block diagram generally illustrating one embodiment of a system 10 for providing the pre-tax purchase of a life insurance policy based on a qualifying individual with no present out-of-pocket expense to an owner of the policy, the policy employing an investment vehicle based on at least one financial index to maintain a cash value of the policy. In one embodiment, system 10 includes a life insurance provider 12, a qualified insured 14, a policy owner 16, a beneficiary 18, and a premium payor 20. In one embodiment, the owner 16 and beneficiary 18 are each part of a common entity 22, such as an insurance trust associated with the qualified insured 14. In one embodiment, the qualified insured 14 and the owner 16 are one and the same, as indicated at 24.

In one embodiment, life insurance provider 12 includes a policy engine 30 which receives data representative of the qualified insured 14, such as the age and asset values of the qualified insured 14, for example, and based on the data, generates a life insurance contract 32 including a death benefit 34, an annual premium 36, and an account or cash component 38. Death benefit 34 includes a fixed net death benefit 40 and an escalating rider component 42, and account or cash component 38 includes a surrender value 44. Life insurance provider 12 further includes an account investment vehicle 50 in which account component 38 is invested, the account investment vehicle 50 providing a rate of return on account component 38 which, as will be described in greater detail below, is based on one or more financial indices 52. Surrender value 44 comprises a portion of account component 38 which is paid to owner 16 if the life insurance policy is terminated prior to the death of qualified insured 14.

According to one embodiment, premium payor 20 finances the annual premiums of the life insurance policy for at least a portion of a life of the policy via a series of loans 54, each at an interest rate, with the loans together having a cumulative loan balance 56. In one embodiment, premium payor 20 comprises a financial institution. In return for financing the annual premiums, the premium payor 20 receives collateral from owner 16 which, as described above may also include the qualified insured 14. The amount of collateral required is based on a difference between surrender value 44 and cumulative loan balance 56. Net death benefit 40 remains fixed for a life of the insurance policy and is paid to beneficiary 18 upon death of the qualified insured 14. Rider component 42 escalates over the life of the insurance policy so as to be equal to cumulative loan balance 56 and is paid to premium payor 20 upon death of qualified insured 14.

By financing the premiums of the life insurance policy 32 via loans 54 from a premium payor or lender 20 and paying off the cumulative loan balance 56 via an escalating rider component 42, the owner 16 (e.g. the qualified insured 14, life insurance trust 22) is able to provide a fixed net death benefit 40 to a beneficiary 18 (e.g. life insurance trust 22) with no current out-of-pocket outlay. Additionally, as will be described in greater detail below, by employing account investment vehicle 5 to provide a rate of return on the cash value or account component 38 based on one or more financial indices 52, life insurance provider 12 is able to better grow and maintain a positive value of account component 38 and thereby longer sustain life insurance policy 32 relative to conventional techniques.

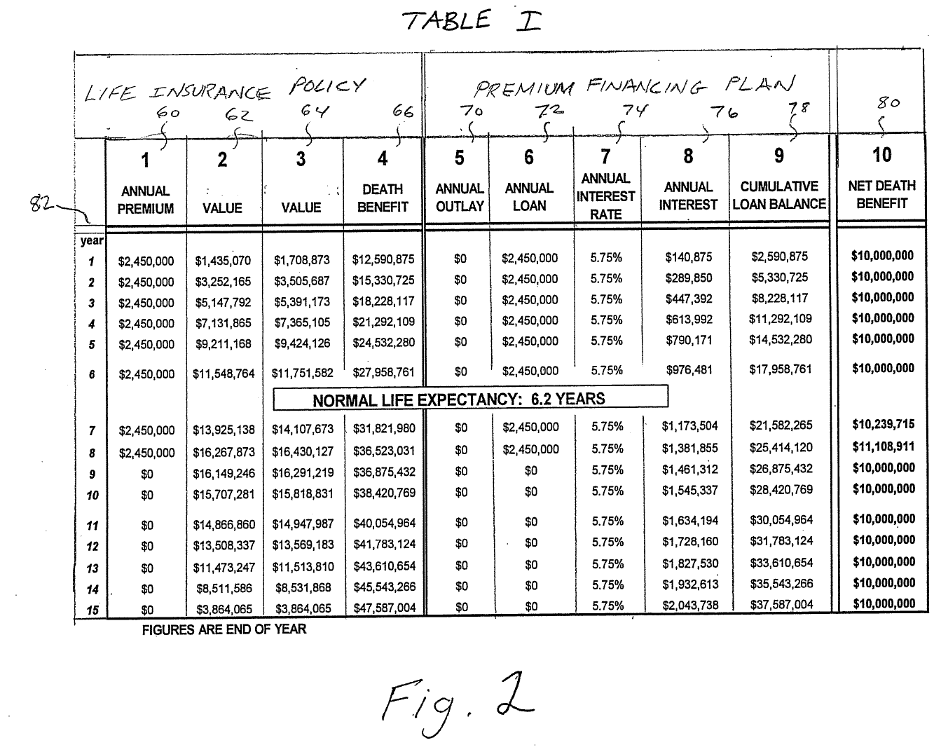

FIG. 2 is a Table I illustrating an example embodiment of a life insurance policy 32 offered by life insurance provider 12 according to system 10 of FIG. 1. Table I includes ten columns. Columns 1-4, as respectively indicated at 60, 62, 64, and 66, describe the example embodiment of life insurance policy 32, while columns 5-9, as respectively indicated at 70, 72, 74, 76, and 78, describe a premium financing plan to fund the annual premium 36 of life insurance policy 32. Column 10, at 80, describes net death benefit 40 provided by life insurance policy 32. The year of operation of life insurance policy 32 is illustrated along the left-hand side of Table I, as indicated at 82. In the example of Table I, it is noted that the operation of life insurance policy 32 is illustrated for 15 years, with qualified insured 14 having a normal or predicted life expectancy of 6.2 years from commencement of life insurance policy 32.

Column “1”, at 60, indicates the annual premium 36 of life insurance policy 32, with the example of Table I having an annual premium 36 of $2,450,000. Column “2”, at 62, indicates a surrender component or surrender value 44 life insurance policy 32, which is paid to owner 16 should life insurance policy 32 be terminated before the death of the qualified insured 14. Column “3”, at 66, indicates account component or account value 38. Each year annual premium 36 is paid, a portion (e.g. the annual premium amount minus costs, fees, commissions, etc.) is paid to account component 38, which is invested in account investment vehicle 50.

According to one embodiment, annual premium 36 is paid each year until account component 38 grows to an amount such that annual premium 36 can be funded from account component 38 for an expecting remaining life of life insurance policy 32. In the example of Table I, account component 38 is illustrated as maintaining annual premium 36 and costs associated with maintenance of life insurance policy 32 by life insurance provider 12 for seven years after payment of a last payment of annual premium 36 via premium payor 20. It is noted that surrender value 44 of column “2” is based on a value of account component 38 of column “3” such as, for example, the value of account component 38 of column “3” minus a penalty for early termination of life insurance policy 32.

Column “4”, at 66, indicates death benefit 34 to be paid by life insurance policy 32 to beneficiary 18 upon the death of the qualified insured 14. As described above, death benefit 34 includes net death benefit 40, which is a fixed amount, as indicated by column “10”, and rider component 42 which increases or escalates each year of the life of the life insurance policy so as to be equal the cumulative loan balance 56 of the premium financing plan provided by premium payor or lender 20. In the example of Table I, net death benefit 40, with reference to column “10” at 80, is equal to $10,000,000.

As mentioned above, columns 5-9 describe the premium financing plan employed to fund annual premium 36 of life insurance policy 32. Column “6”, as indicated at 72, indicates an amount of annual loan 54 provided by lender 20 to life insurance provider 12 to pay annual premium 36. As such, annual loan 54 of column “6” is equal to annual premium 36 of column “1”. According to one embodiment, annual premium 36 is funded via the premium financing plan until account component 38 of column “3” has a value sufficient to fund annual premium 36 for an expected remaining life of life insurance policy 32. In the example of Table I, annual premium 36 is funded via the premium financing plan for the first 8 years. Column “5”, as indicated at 70, illustrates the annual “out-of-pocket” outlay by owner 16 (who may or may not be the qualified insured 14), which is zero for the life of the life insurance policy 32 (i.e. “zero outlay”).

Column “7”, as indicated at 74, illustrates the annual interest rate of annual loans 54 provided as part of the premium financing plan by lender 20. In the example of Table I, the annual interest rate is 5.75%. Column “8”, as indicated at 76, illustrates the annual interest accrued on annual loans 54 of column “6” and on cumulative loan balance 56, which is illustrated by column “9”, as indicated at 78.

Column “10” indicates net death benefit 40 paid to beneficiary 18 of life insurance policy 32 (e.g. an heir, a life insurance trust fund) upon death of qualified insured 14. As described above, net death benefit 40 of column “10” is a fixed component of death benefit 34 provided by life insurance policy 32, as indicated by column “4”, while rider component 42 is an escalating component which is adjusted so as to be equal to cumulative loan balance 56 of column “9”. As such, in any given year during the life of life insurance policy 32, the sum of net death benefit 40 of column “10” and cumulative loan balance 56 of column “9” is equal to death benefit 40 of column “4”.

In order to obtain annual loans 54 of the premium financing plan, owner 16 of life insurance policy 32 must provide on-going collateral for a difference in value between cumulative loan balance 56 of column “9” and the surrender component or surrender value 44 of column “2”. The collateral may be satisfied by a pledge of securities, letters of credit, real estate, and other cash values, for example. A description of the collateral requirement will be provided in greater detail later herein. However, as this point, it is noted that the pledged collateral remains under the control of owner 16 who can manage and/or direct management of the pledged collateral, with the total pledged collateral being released at the death of qualified insured 14 at which point rider component 42 of death benefit 34 of column “4” pays off cumulative loan balance 56 of column “9”.

As mentioned above, account component 38 of life insurance policy 32, as indicated by column “3”, is invested in account investment vehicle 50. In one embodiment, account investment vehicle 50 provides a fixed rate of return. In one embodiment, account investment vehicle 50 provides a variable rate of return based on at least on one financial index 52. In one embodiment, the variable rate of return is based on the S&P 500 Index. According to one embodiment, the rate of return comprises a sliding average of the S&P 500 Index over a selected sliding time period or holding period. In embodiment, the rate of return is based on 5-year holding period. In embodiment, the rate of return is based on 10-year holding period. In embodiment, the rate of return is based on 20-year holding period.

In one embodiment, in addition to being based on a sliding average of the S&P 500 Index, the rate of return of account investment vehicle 50 has a “floor” rate (i.e. a guaranteed minimum rate of return) and a “cap” rate (i.e. a maximum rate of return). In one embodiment, account investment vehicle 50 has a floor rate of 1% and a cap rate of 12%. According to such an embodiment, if the average return of the S&P 500 Index for the selected holding period is −10%, for example, the rate of return provided by account investment vehicle 50 will be 1%. Similarly, if the average return of the S&P 500 Index for the selected holding period is 20%, the rate of return provided by account investment vehicle 50 will be 12%.

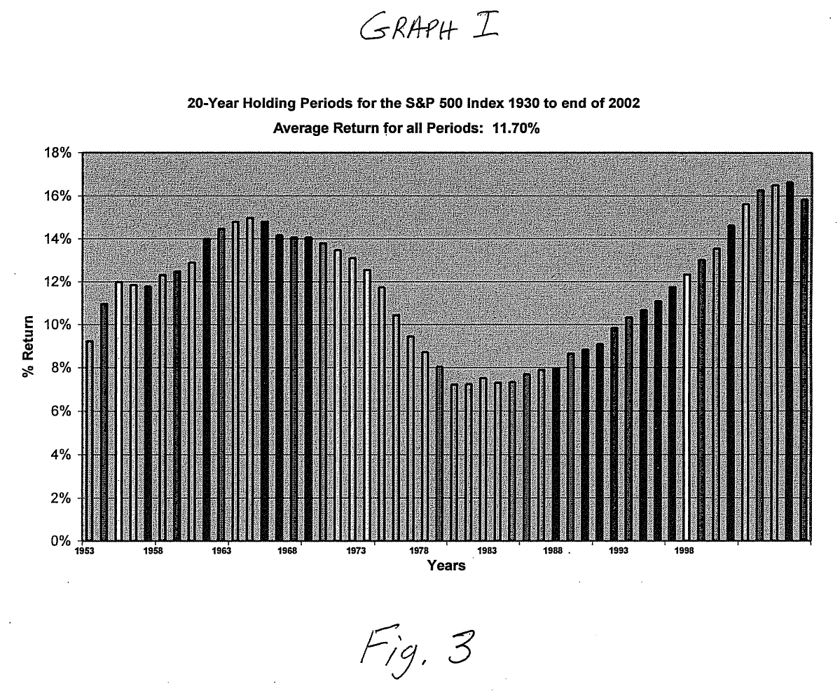

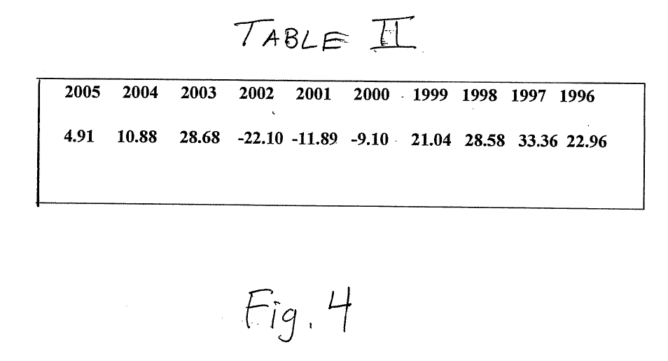

FIG. 3 is a Graph I illustrating the average returns of 20-year holding periods for the S&P 500 Index from 1930 through the end of 2002. The average return for all 20 year periods in this time span was 11.7%. FIG. 4 is Table II illustrating the annual rate of return of the S&P 500 Index for a 10 year period from 1996 to 2005, including the three-year market period of 2000-2002 which included the “Dot.com Meltdown”. In spite of a cumulative rate of return of −44% during this three year period, the ten year average of the S&P 500 Index over the ten year period was 13.7%. According to one embodiment, by employing a floor rate of 1%, the −44% rate of return during the 2000-2002 time period would have instead provided a positive cumulative rate of return of 3%. Employing a 1% floor and a 12% cap results in account investment vehicle 50 providing an average rate of return for this 10 year period of 7.9%.

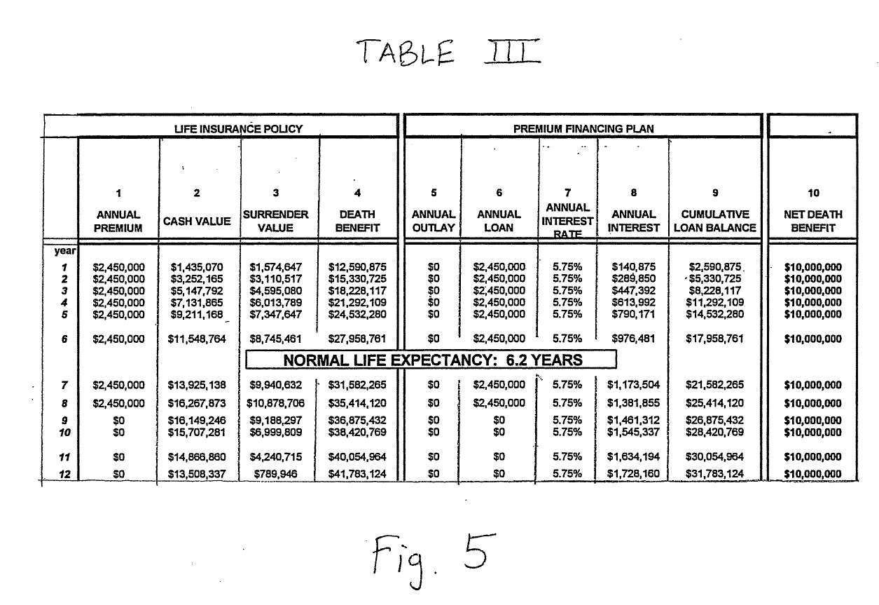

As mentioned above, in one embodiment, account investment vehicle 50 provides a 1% floor rate, meaning that if the S&P 500 Index post a negative rate of return, for example, account investment vehicle 50 still proves a positive 1% rate of return. FIG. 5 is a Table III illustrating the example embodiment described by Table I of FIG. 2, but showing the results if the S&P 500 Index provided a rate of return less than 1% for the life of insurance policy 32, meaning that the floor rate of 1% was in effect for the life of life insurance policy 32. Even in this extreme scenario, account investment vehicle 50 maintains account component 38 at a cash value great enough to sustain life insurance policy 32 for six years beyond the estimated normal life expectancy of qualifying insured 14.

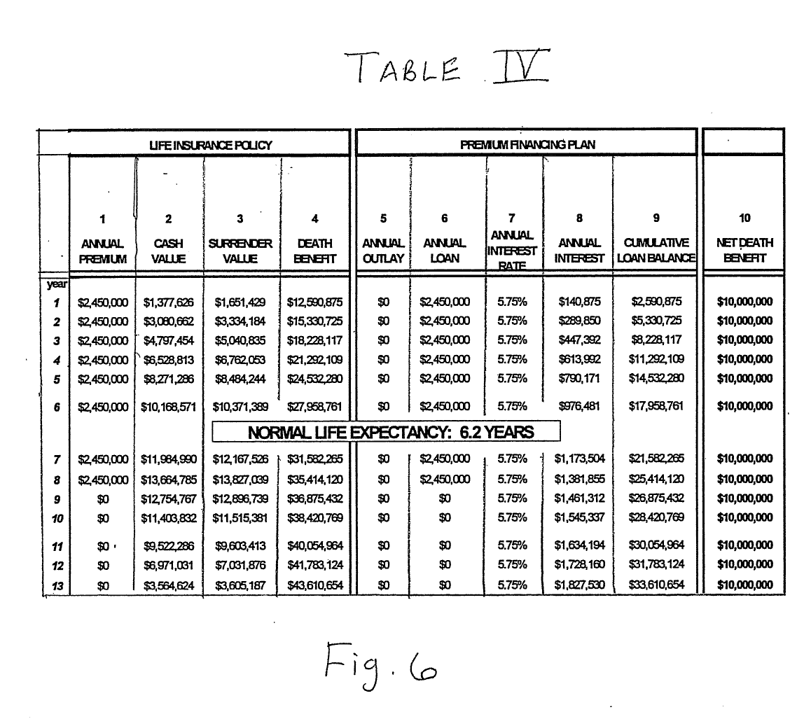

Also, in one embodiment, as mentioned above, rather than being based on an index fund, such as the S&P 500 Index, account investment vehicle 50 provides a fixed rate of return based on investing account component 38 in a Fixed Fund. FIG. 6 is a Table IV illustrating the example embodiment described by Table I of FIG. 2, but showing the results when account investment vehicle 50 provides a fixed rate of return of 5.40%. In such a scenario, account investment vehicle 50 maintains account component 38 at a cash value great enough to sustain life insurance policy 32 for seven years beyond the estimated normal life expectancy of qualifying insured 14.

In one embodiment, the rate of return of the account investment vehicle 50 is based on a combination of the returns of multiple financial indices 52 and configured to provide increased growth of account component 38 relative to employing only a single financial index. In one embodiment, account investment vehicle 50 is based on the returns of three financial indices. In one embodiment, the three global financial indices employed include the S&P 500, the EuroStoxx 50, and the Hang Seng, respectively representing the financial markets of the United States, Europe, and Asia. Tracking three global indices in this fashion provides improved diversification and better insulation against a downturn in any one global region.

In one embodiment, wherein the three indices described above are employed to form a composite index, account investment vehicle 50 provides a guaranteed minimum rate of return (i.e. a floor) of 2.5%, and a top rate of return in any given year which is equal to a percentage of a composite rate of return of the three indices. In one embodiment, the top rate of return is equal to 55% of a composite rate of return of the three indices. According to such an embodiment, in any given year, the rate of return provided by account investment vehicle 50 will be between 2.5% and 55% percent of a rate of return of the composite index. In one embodiment, the composite index is based on equal weighting of the three indices.

In one embodiment, the composite index is based on a hindsight feature which includes a look back allocation feature looks that includes performance-based weighting factors that weights a contribution of each of the three indices to the composite index based on its performance relative to the three indices. In one embodiment, the contribution to the composite index of the best performing of the three indices is weighted at 75%, the second best performing index is weighted at 25%, and the worst performing index at 0%. In one embodiment, this composite “hindsight” index is based on a 5-year holding period of the indices.

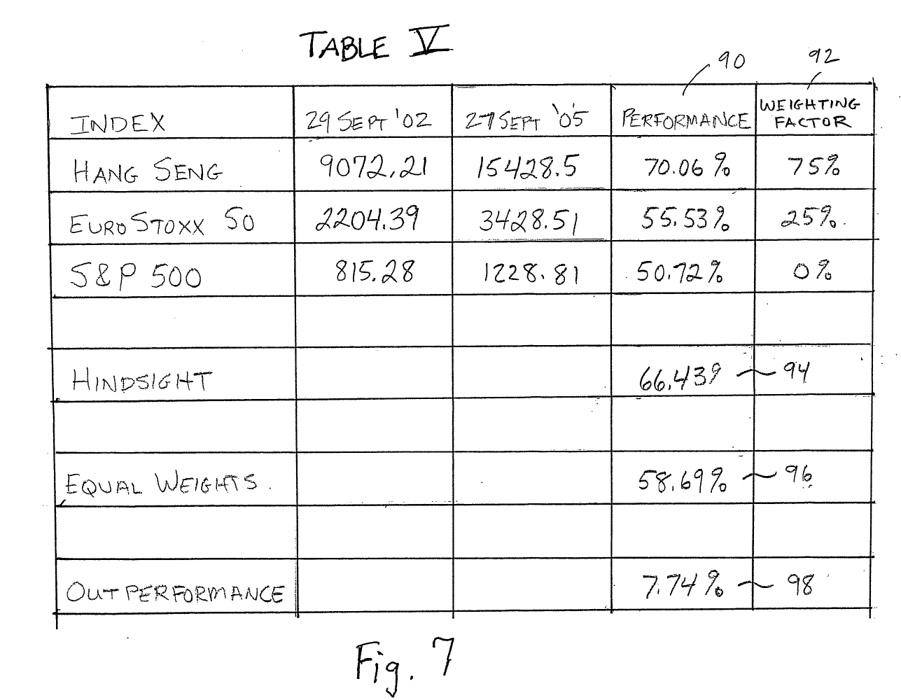

FIG. 7 is a Table V illustrating the performances of the Hang Seng, EuroStoxx 50, and S&P 500 indices over a 3-year period from Sep. 29, 2002, to Sep. 27, 2005 and demonstrates the results of employing the above described hindsight index using performance-based weighting factors relative to an equal weighting for each of the three indices. As illustrated, by the “performance” column at 90, over this time period, the Hang Seng Index increased by 70.06%, the EuroStoxx 50 Index by 55.53%, and the S&P 500 Index by 50.72%. Applying the above described performance based weighting factors, as indicated by the “weighting factor” column at 92 results in a hindsight performance of 66.43%, as indicated at 94. Without employing the look-back feature and performance-based weighting factors of the hindsight feature and equally applying the performance of each of the three indices equally to the composite index (i.e. equally weighted at 33.3% per index) results in a performance of 58.69%, as indicated at 96. As such, the hindsight index employing the look-back feature outperformed the composite index without such a look-back feature by 7.74%, as indicated at 98.

Account investment vehicle 50 employing the above described hindsight index based on 5-year holding periods of the Hang Seng, EuroStoxx 50, and S&P 500 Indices, and employing a 2.5% floor and a yearly cap of 55% of the hindsight rate of return also outperforms the earlier described embodiment of account investment vehicle 50 employing only the S&P 500 Index and having a floor rate of 2% and a yearly cap rate of 12%.

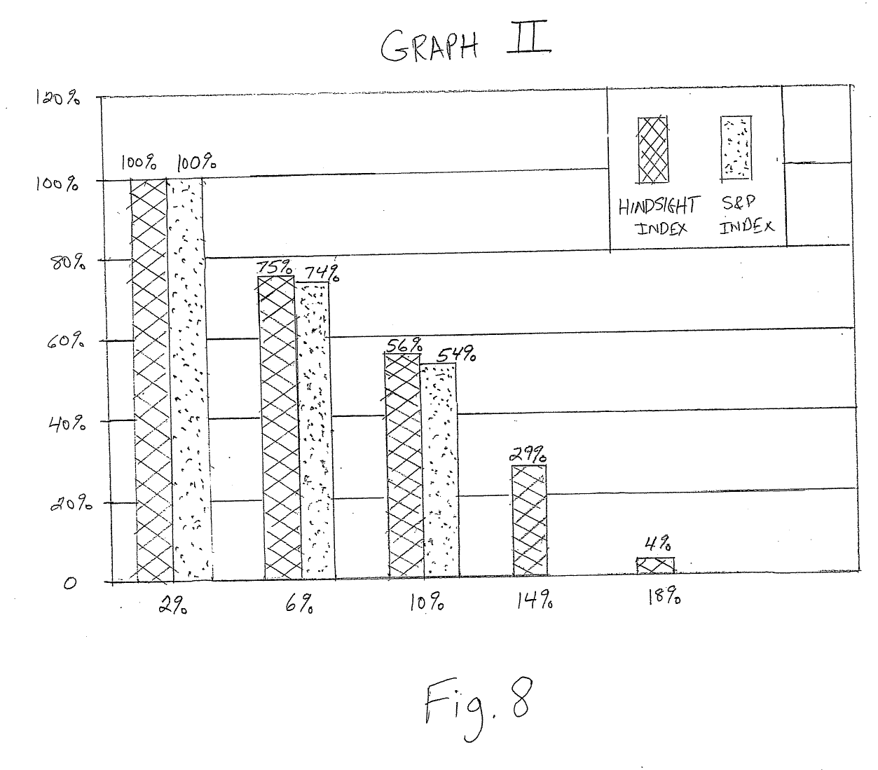

FIG. 8 is a Graph II comparing the performance of investment vehicle 50 using the above-described hindsight index based on the Hang Seng, EuroStoxx 50, and S&P 500 Indices to using the earlier described embodiment using only the S&P 500 Index with a 2% floor and a 12% cap for a time period between 1970 and 2005. Graph II illustrates use of a 5-year holding period for each of the approaches. As illustrated, each of the approaches provided at least a 2% rate of return for all, or 100%, of the 5-year holding periods. The hindsight index provided a return of 6% for 75% of the 5-year holding periods as compared to 74% for the S&P 500-12% cap approach. The hindsight index provided a return of 10% for 56% of the 5-year holding periods as compared to 54% for the S&P 500-12% cap approach. However, the hindsight index provided a return of 14% for 29% of the 5-year holding periods and a return of 18% for 4% of the 5-year holding periods, while the S&P 500-12% cap approach never provided such a rate of return. As is evident from Graph II, the hindsight index embodiment of account investment vehicle 50 outperforms the S&P 500-12% cap approach.

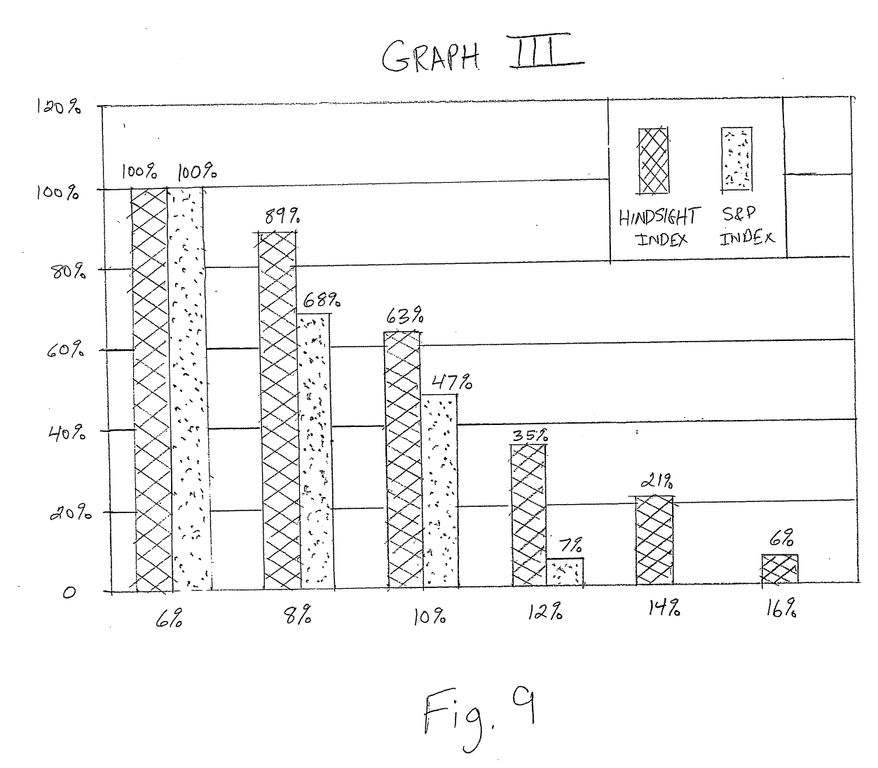

FIG. 9 is Graph III comparing to the same two approaches using 10-year holding periods. As illustrated by Graph III, the hindsight index embodiment of account investment vehicle 50 outperforms the S&P 500-12% cap approach by even greater margins when using 10-year holding periods.

According to one embodiment, where account investment vehicle 50 employs the above-described weighted hindsight index based on 5 year holding periods of the Hang Seng, EuroStoxx 50, and S&P 500 Indices, and provides a minimum rate of 2.5% and a top rate of 55% of the weighted composite rate, the annual rate of return provided by account investment vehicle 50 is set at the minimum rate of 2.5% for the first 5 years of the life insurance policy. Beginning with the end of the fifth year, the minimum rates of 2.5% for the first through the fifth years are backward adjusted (but not below the 2.5% floor) based on a five year holding period of which the year is the first year. For example, the years one through five are used to backward adjust the rate of return for the first year of the policy, years two through six are used to backward adjust the rate of return for the second year of the policy, and so one. Beginning at year 6 and extending for a duration of the life insurance policy, the rate of return is based on a five year holding period for which the given year comprises the final year of the holding period.

As mentioned above, in order to obtain the annual loans 54 of the premium financing plan, owner 16 of life insurance policy 32 must provide on-going collateral for a difference in value between cumulative loan balance 56 of and the surrender component or surrender value 44 of life insurance policy 32. The collateral may be satisfied by a pledge of securities, letters of credit, real estate, and other cash values, to name a few. The pledged collateral remains under the control of owner 16 who can manage and/or direct management of the pledged collateral, with the total pledged collateral being released at the death of qualified insured 14 at which point rider component 42 of death benefit 34 is paid to premium payor/lender 20 to pay off cumulative loan balance 56.

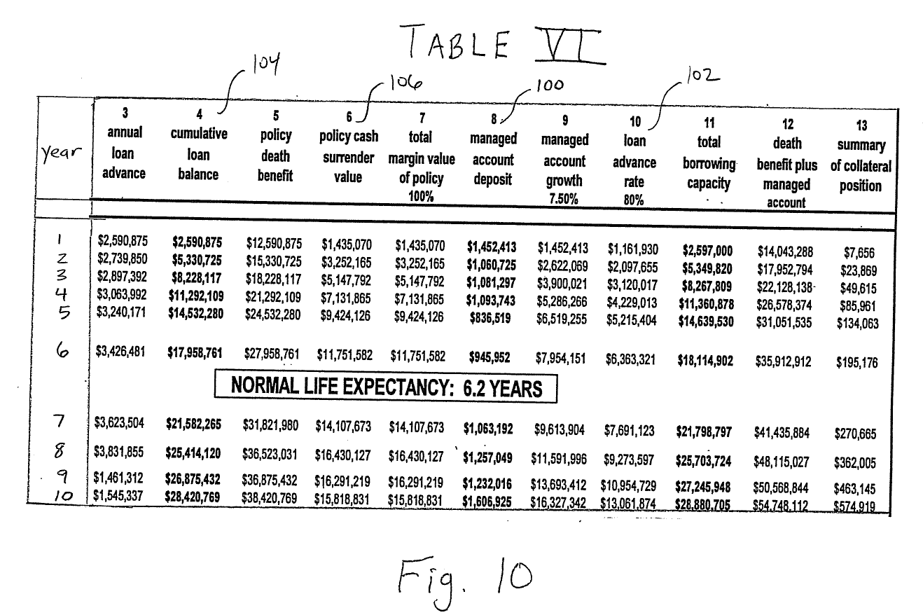

FIG. 10 is a Table VI illustrating the on-going collateral required for the example described by Table I of FIG. 2. The on-going collateral pledges or deposits are illustrated by “Managed Account Deposit” of column “8”, as indicated at 100. In some embodiments, premium payor accepts only 80% of the value of the pledged collateral, as illustrated by the “Loan Advance Rate” of column “10”, as indicated at 102. As such, the “Loan Advance Rate” of column “10” must at least be equal to the difference in value between the cumulative loan balance 56 and the surrender value 44, as respectively illustrated by columns “4” and “6” at 104 and 106.

According to one embodiment, the required collateral required for the premium financing plan may be mitigated purchasing an additional conventional life insurance policy on the qualified insured 14. In one embodiment, this conventional life insurance policy is then sold to an insurance pool maintained as investment options by some financial institutions, with the proceeds of the sale of the conventional life insurance policy being used as collateral for the premium financing plan.

In summary, the embodiments of the life insurance system and method described herein provide the pre-tax purchase of a life insurance policy based on a qualifying individual with no present out-of-pocket expense to an owner of the policy and to cover its own financing costs. By employing an account investment tool providing a rate of return on a cash value of the life insurance policy based on a plurality of global financial indices, the life insurance system is better able to grow and maintain the cash value of the policy and thereby sustain the life insurance policy for a longer duration relative to conventional techniques.

The present invention may be employed using software, hardware, or a combination of software and hardware. The software may be employed on one or more computers, or a centralized computing system via a network. In one embodiment, the present invention is employed on a web-based system via the Internet.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A system for providing life insurance with no out-of-pocket cost comprising:
a cost component;
an increasing death benefit having a fixed portion and a rider portion, the rider portion being at least equal to a cumulative loan balance; and
an investment vehicle configured to provide a rate of return on the cash component based on more than one financial market index.

2. The system of claim 1, wherein the investment vehicle provides an annual rate of return which is a fixed rate.

3. The system of claim 1, wherein the investment vehicle provides an annual rate of return which is variable.

4. The system of claim 3, wherein the investment vehicle provides an annual rate of return in a given year is within a range from a floor rate to a ceiling rate.

5. The system of claim 4, wherein the floor rate is 1.0% and the ceiling rate is 12%.

6. The system of claim 3, wherein the annual rate of return is based on a plurality of financial indices.

7. The system of claim 6, wherein the annual rate of return is based on three financial indices.

8. The system of claim 7, wherein the annual rate of return on average returns of each of the three financial indices over a holding period having a desired duration.

9. The system of claim 8, wherein the desired duration comprises 5 years.

10. The system of claim 7, wherein a contribution to the annual rate of return of each of the three financial indices in a given year is weighted based on relative performances of the three financial indices.

11. The system of claim of claim 10, wherein a contribution of a best performing of the three financial indices is weighted with a weighting factor of 0.75, a worst performing of the three financial indices is weighted with a weighting factor of 0.0, and a remaining of the three financial indices is weighted with a weighting factor of 0.25.

12. The system of claim 6, wherein the annual rate of return has a minimum value and a capped value equal to a cap percentage of a composite rate of return based on the plurality of financial indices.

13. The system of claim 7, wherein the three indices comprise the S&P 500, the Hang Seng, and the EuroStoxx 50 indices.

14. A method of providing life insurance, the method comprising:
defining a life insurance policy based on a qualifying individual, the life insurance policy having a premium and including a cash component and a death benefit having a fixed component and a rider component
financing the premiums for at least a portion of a life of the life insurance policy with one or more loans which together define a cumulative loan balance;
adjusting the rider component of the death benefit so as to have a value equal to the cumulative loan balance; and
investing the cash component in an investment vehicle providing a rate of return based on more than one financial index.

15. The method of claim 14, including providing collateral for a difference between a surrender value of the life insurance contract and the cumulative loan balance.

16. The method of claim 14, including paying off the cumulative loan balance to a lender providing the annual loans with the variable component of the death benefit and the fixed component of the death benefit to an estate of the individual upon the individual's death.

17. The method of claim 14, including basing the rate of return of the investment vehicle on three financial indices.

18. The method of claim 17, including weighting a contribution of each of the three financial indices to the annual rate of return in a given year is weighted based on relative performances of the three financial indices.

19. The method of claim of claim 17, including weighting a contribution of a best performing index with a weighting factor of 0.75, of a second best performing index with a weighting factor of 0.25, and a worst performing index with a weighting factor of zero.

20. The method of claim 18, including providing a minimum rate of return and a capping the rate of return at a cap percentage of a composite rate of return of the three financial indices.

21. The method of claim 20, minimum rate of return is 2.5% and the cap percentage is 55%.

22. A method of providing life insurance with no out-of-pocket cost comprising:
defining a life insurance policy having a death benefit including a cash component and a death benefit having a fixed portion and a rider portion, the rider portion being at least equal to a cumulative loan balance; and
increasing the cash component using an investment vehicle associated with more than one financial market index.
